(19) United States
(12) Patent Application Publication
(10) Pub. No.: US 2008/0193651 A1
(43) Pub. Date: Aug. 14, 2008

(54) Surface Modification Of Solid Support Materials

(76) Inventors: Dieter Lubda, Bensheim (DE); Urs Welz-Biermann, Heppenheim (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/994,567

(22) PCT Filed: Jun. 12, 2006
(86) PCT No.: PCT/EP2006/005612

§ 371 Date: Jan. 3, 2008

(30) Foreign Application Priority Data
Jul. 4, 2005 (DE) 102005031166.0

(51) Int. Cl. B01J 20/02; B05D 3/02

(52) U.S. Cl. 427/314; 502/405

(57) ABSTRACT

The present invention relates to a process for the surface modification of solid support materials, in particular chromatography materials, using silanes, in which the surface modification is carried out in the presence of ionic liquids.

The present invention relates to a process for the surface modification of solid support materials, in particular chromatography materials, using silanes, in which the surface modification is carried out in the presence of ionic liquids.

The use of unmodified and modified inorganic or organic support materials for the separation of substance mixtures has already been known for more than 50 years. High-performance liquid chromatography (HPLC) has developed in the last 25 years into one of the most widespread chromatographic separation and analysis methods.

For chromatographic separations, a number of support materials, for example SiO₂, Al₂O₃ or organic polymers, can be used directly as sorbent. However, these materials more frequently serve as base material which is modified in a suitable manner by means of separation effectors. In this way, the adsorptive properties of the sorbent are modified, enabling a multiplicity of different separation methods. Particularly common is the binding of long hydrocarbon chains as separation effectors for the preparation of, for example, reversed-phase silica gel. Today, about 80% of chromatographic separations are carried out on materials having reversed-phase properties. The binding of the alkane chains can be carried out via various reactions. Thus, reactions with alkylchlorosilanes or alkoxysilanes have been described. Furthermore, monofunctional, di- or trifunctional ligands can be used for the reaction with the sorbent.

Monofunctional ligands react well and reproducibly with the sorbent, but are easily removed by hydrolysis. Di- and trifunctional ligands exhibit higher hydrolysis stability, but can only be bound to the sorbent with lower reproducibility.

The aim of surface modification is generally to mask the properties of the support material that were originally present as completely as possible. Otherwise, interaction of the analytes with the support material may result in undesired secondary (nonspecific) interactions, which are evident in the chromatogram through tailing of the substance peaks.

Besides acidic components, many analytes, such as, for example, pharmaceutical active compounds, frequently also comprise basic and/or chelating components, which make good and complete screening of the surface of the support material, in the case of silica gel screening of the silanol groups, necessary in order to achieve efficient chromatographic separation. This is due to the acidic properties of the silanol groups. In the case of incomplete screening, these silanol groups result in secondary interactions.

The various types of surface silanol groups in silica gel materials and the possible modification products after binding of organic functionalities have already been investigated by means of many physical analyses of the surface.

For the absolute determination of the amount of carbon, elemental analysis is employed. Solid-state NMR analysis has proven to be one of the most high-performance methods for investigating the type of binding. Besides the silanol groups, 29 Si measurements also enable the various silane components to be specified with their different types of binding. By means of analytical methods of this type, it has been found, for example, that a degree of crosslinking of only 24% is achieved in the case of conventional modification of a silica gel material using trifunctional silanes.

Silica gels typically have about 8 μmol/m² of silanol groups on the surface (Porous Silica, K. K. Unger, Elsevier Scientific Publishing Company, 1979, page 104). However, only about half of these silanol groups can be reached by conventional modification methods. It is therefore of major importance to find ways of screening the surface as completely as possible.

One possibility is so-called end capping. After reaction of the support material with the desired, usually relatively long-chain separation effector, the material is reacted again with a shorter-chain silane, for example hexamethyldisilazane (HMDS). This shorter-chain silane is less bulky and can thus react with silanol groups which are sterically out of reach of the relatively long-chain separation effector. This end capping of the silanol groups which can still be reacted can result in an increase in the degree of reaction of up to 10% and thus reduce the nonspecific interactions.

The disadvantage of this method is that the short-chain modifications only exhibit lower stability in routine chromatography, and for this reason an undesired change in the selectivity may be observed after a relatively short use duration.

Another way of screening the silica gel surface is disclosed in WO 93/25307. Through defined surface wetting with water and use of trifunctional silanes, a monomolecular layer is produced and crosslinked on the surface.

However, none of the known methods offers a way of producing surface modification with complete screening of the support material and at the same time long service lives. The object of the present invention was therefore to find an alternative method of introducing a stable surface modification.

It has been found that use of ionic liquids as solvent for the surface modification gives chromatographic support materials having good crosslinking of the silane modification and good chromatographic separation properties. It has been found that surface modification using ionic liquids can be employed particularly advantageously in the introduction of separation effectors into monolithic support materials.

The present invention therefore relates to a process for the surface modification of solid support materials, characterised by the following reaction steps
a) provision of a solid support material
b) reaction of the solid support material with silanes in the presence of ionic liquid as solvent
c) separation of the support material
d) optionally washing and drying of the support material.

In a preferred embodiment, the solid support material provided in step a) is a silica gel material.

In a particularly preferred embodiment, the support material provided in step a) is a monolithic silica gel material.

In another preferred embodiment, the reaction in step b) is carried out in the presence of pure ionic liquid without addition of organic solvents.

In another preferred embodiment, the reaction in step b) is carried out at a temperature between 200 and 400° C.

In a further preferred embodiment, the reaction in step b) is carried out in the presence of a hydrophobic ionic liquid.

In a preferred embodiment, the silanes employed in step b) are bifunctional silanes.

In a further embodiment, a support material which already carries separation effectors is employed in step a). In this case, the reaction according to the invention serves for end capping.

In a further embodiment, a polymer layer is applied in a subsequent step f) after the surface modification according to the invention has been carried out.

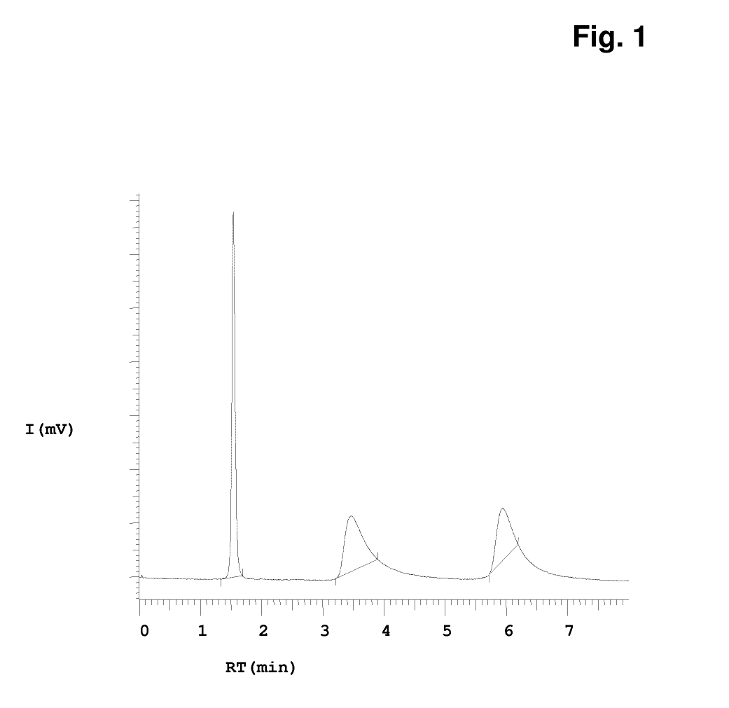

FIGS. 1 to 4 show chromatograms of separations that have been carried out using materials in accordance with the prior art or materials according to the invention. Further explanations are given in the examples.

For the purposes of the present invention, solid support materials are inorganic or organic support materials which carry, at least on their surface, functional groups which are able to react with silanes. Examples of suitable materials are optionally correspondingly functionalised polyacrylamides, polyacrylates, vinyl polymers or polystyrene-divinylbenzene copolymers or silica gel, silicates, metal oxides, such as aluminium oxide, iron hydroxides, hydroxylapatite or glass, or also composite materials, for example comprising silicon dioxide with fractions of other oxides, such as, for example, ZrO₂. Also suitable are inorganic/organic hybrid materials. These can be, for example, firstly organic/inorganic copolymers or silica hybrid materials in which the monomer sol comprises not only alkoxysilanes, but also organoalkoxysilanes, i.e. typically at least 10%, preferably 20 to 100%, of organoalkoxysilanes. Examples of particulate hybrid materials are given, for example, in WO 00/45951 or WO 03/014450.

Preference is given to materials which carry Si—OH groups on the surface. Particular preference is given to silica gel or silica hybrid materials.

The support materials may be porous or nonporous, in the form of, for example, particles, monolithic mouldings, fibres, membranes, filters or correspondingly modified vessel walls. Preference is given to particulate or monolithic materials. In the case of monolithic materials, particular preference is given to brittle, inorganic mouldings, as disclosed in WO 94/19 687, WO 95/03 256 or WO 98/29 350. These monolithic materials particularly preferably have a bimodal pore distribution with macropores and mesopores in the walls of the macropores.

For the purposes of the present invention, silanes are all Si-containing compounds which have at least one functionality by means of which they are able to undergo covalent bonding to the support material (corresponds to L in formula A) and at least one functionality which can serve as separation effector or for end capping (corresponds to R in formula A). In general, these are mono-, di- or trifunctional silanes, such as alkoxy- or chlorosilanes. Other reactive Si-containing compounds, such as silazanes, siloxanes, cyclic siloxanes, disilazanes and disiloxanes, also fall under the term “silanes” for the purposes of the invention.

Examples of suitable silanes are given by formula A,

LₙRₘSi A

where
1≦m≦3 and
1≦n≦3
and where n+m together gives 4,
L is Cl, Br, I, C₁-C₅ alkoxy, dialkylamino or trifluoromethanesulfonate, and
R is straight-chain or branched C₁ to C₃₀ alkyl (such as, for example, methyl, ethyl, n-propyl, isopropyl, n-butyl, tert-butyl, sec-butyl, cyclohexyl, octyl, octadecyl), alkenyl, alkynyl, aryl (such as phenyl) or alkaryl (such as C1-C5-phenyl), cyano or cyanoalkyl (such as cyanopropyl), aminoalkyl or hydroxyalkyl (such as aminopropyl or propyldiol), nitro, esters, ion exchangers, etc.

R here in the case of m=2 or 3 may also have two or three different meanings, so that one to three identical or different radicals R may be pre-sent in one molecule.

More precise details of the reagents are known to the person skilled in the art and are given, for example, in K. K. Unger, Porous Silica, Elsevier Scientific Publishing Company, 1979. In a preferred embodiment, the silanes employed in accordance with the invention are bifunctional silanes.

Examples of particularly suitable separation effectors are ionic, hydrophobic, chelating or chiral groups, for example ionic groups, such as the carboxyl or sulfonyl group for cation exchange chromatography, alkylated amino or ammonium groups for anion exchange chromatography, long- and medium-chain alkyl groups or aryl groups for reversed-phase chromatography.

Further details on possible separation effectors and suitable silanes are given in WO 94/19687, in particular on pages 4 and 5.

Silanes having an end-capping functionality are known to the person skilled in the art. These are silanes which do not contain any sterically bulky radicals and are thus also able to react with functionalities on the support material, which cannot be achieved by silanes containing large radicals.

Suitable silanes having an end-capping functionality are, for example, dimethyldimethoxysilane or hexamethyldisilazane.

Ionic liquids which are suitable in accordance with the invention are all ionic liquids in which surface modification of solid support materials can be carried out using silanes, in particular owing to their dissolution behaviour and reactivity. In general, pure ionic liquids or mixtures of ionic liquids without addition of organic solvents are preferably used for carrying out the surface modification in accordance with the invention. In individual cases, however, the addition of up to 50% of typically high-boiling organic solvents which have adequate miscibility with the ionic liquids may also be beneficial. “In the presence of ionic liquid as solvent” therefore means in accordance with the invention: in the presence of a pure ionic liquid or a mixture of at least two ionic liquids or one or more ionic liquids mixed with up to 50% of one or more organic solvents. Preference is given in accordance with the invention to the use of a pure ionic liquid.

Review articles on ionic liquids are, for example, R. Sheldon “Catalytic reactions in ionic liquids”, Chem. Commun., 2001, 2399-2407; M. J. Earle, K. R. Seddon “Ionic liquids. Green solvent for the future”, Pure Appl. Chem., 72 (2000), 1391-1398; P. Wasserscheid, W. Keim “Ionische Flüssigkeiten—neue Lösungen für die Übergangsmetallkatalyse” [Ionic Liquids—Novel Solutions for Transition-Metal Catalysis], Angew. Chem., 112 (2000), 3926-3945; T. Welton “Room temperature ionic liquids. Solvents for synthesis and catalysis”, Chem. Rev., 92 (1999), 2071-2083, or R. Hagiwara, Ya. Ito “Room temperature ionic liquids of alkylimidazolium cations and fluoroanions”, J. Fluorine Chem., 105 (2000), 221-227.

Ionic liquids or liquid salts are ionic species which consist of an organic cation and a generally inorganic anion. They do not contain any neutral molecules and usually have melting points below 373 K. However, the melting point may also be higher without restricting the usability according to the invention of the salts. Examples of organic cations are, inter alia, tetraalkylammonium, tetraalkylphosphonium, N-alkylpyridinium, 1,3-dialkylimidazolium or trialkylsulfonium. Amongst a multiplicity of suitable anions, mention may be made, for example, of BF₄⁻, PF₆⁻, SbF₆⁻, NO₃⁻, CF₃SO₃⁻, (CF₃SO₂)₂N⁻, arylSO₃⁻, CF₃CO₂⁻, CH₃CO₂⁻ or Al₂Cl₇⁻.

Further examples of suitable organic cations are:

ammonium cations of the formula (1)

[NR₄]⁺ (1),

phosphonium cations of the formula (2)

[PR₄]⁺ (2),

where
R in each case, independently of one another, denotes
H, where all substituents R cannot simultaneously be H,
OR′, NR′₂, with the proviso that a maximum of one substituent R in formula (1) is OR′, NR′₂,
straight-chain or branched alkyl having 1-20 C atoms,
straight-chain or branched alkenyl having 2-20 C atoms and one or more double bonds,
straight-chain or branched alkynyl having 2-20 C atoms and one or more triple bonds,
saturated, partially or fully unsaturated cycloalkyl having 3-7 C atoms,
which may be substituted by alkyl groups having 1-6 C atoms,
where one or more R may be partially or fully substituted by halogens, in particular —F and/or —Cl, or partially by —OH, —OR′, —CN, —C(O)OH, —C(O)NR′₂, —SO₂NR′₂, —C(O)X, —SO₂OH, —SO₂X, —NO₂,
and where, in R, one or two non-adjacent carbon atoms which are not in the α-position may be replaced by atoms and/or atom groups selected from the group O—, —S—, —S(O)—, —SO₂—, —SO₂O—, —C(O)—, —C(O)O—, —N⁺R′₂—, —P(O)R′O—, —C(O)NR′—, —SO₂NR′—, —OP(O)R′O—, —P(O)(NR′₂)NR′—, —PR′₂═N— or —P(O)R′—, where R′=H, non-, partially or perfluorinated C₁- to C₆-alkyl, C₃- to C₇-cycloalkyl, unsubstituted or substituted phenyl, and X=halogen.

Uronium cations can be described, for example, by the formula (3)

[(R¹R²N)—C(═OR⁷)(NR³R⁴)]⁺ (3),

thiouronium cations by the formula (4)

[(R¹R²N)—C(═SR⁷)(NR³R⁴)]⁺ (4),

guanidinium cations by the formula (5)

[C(NR¹R²)(NR³R⁴)(NR⁵R⁶)]⁺ (5),

where
R¹ to R⁷ each, independently of one another, denote
hydrogen, where hydrogen is excluded for R⁷,
straight-chain or branched alkyl having 1 to 20 C atoms,
straight-chain or branched alkenyl having 2-20 C atoms and one or more double bonds,
straight-chain or branched alkynyl having 2-20 C atoms and one or more triple bonds,
saturated, partially or fully unsaturated cycloalkyl having 3-7 C atoms,
which may be substituted by alkyl groups having 1-6 C atoms,
where one or more of the substituents R¹ to R⁷ may be partially or fully substituted by halogens, in particular —F and/or —Cl, or partially by —OH, —OR′, —CN, —C(O)OH, —C(O)NR′₂, —SO₂NR′₂, —C(O)X, —SO₂OH, —SO₂X, —NO₂, but where all substituents on an N atom cannot be fully substituted by halogens,
and where, in the substituents R¹ to R⁶, one or two non-adjacent carbon atoms which are not bonded directly to the heteroatom may be replaced by atoms and/or atom groups selected from the group —O—, —S—, —S(O)—, —SO₂—, —SO₂O—, —C(O)—, —C(O)O—, —N⁺R′₂—, —P(O)R′O—, —C(O)NR′—, —SO₂NR′—, —OP(O)R′O—, —P(O)(NR′₂)NR′—, —PR′₂═N— or —P(O)R′—, where R′=H, non-, partially or perfluorinated C₁- to C₆-alkyl, C₃- to C₇-cycloalkyl, unsubstituted or substituted phenyl, and X=halogen.

Heterocyclic cations can be described, for example, by the formula (6)

[HetN]⁺ (6)

where
HetN⁺ denotes a heterocyclic cation selected from the group

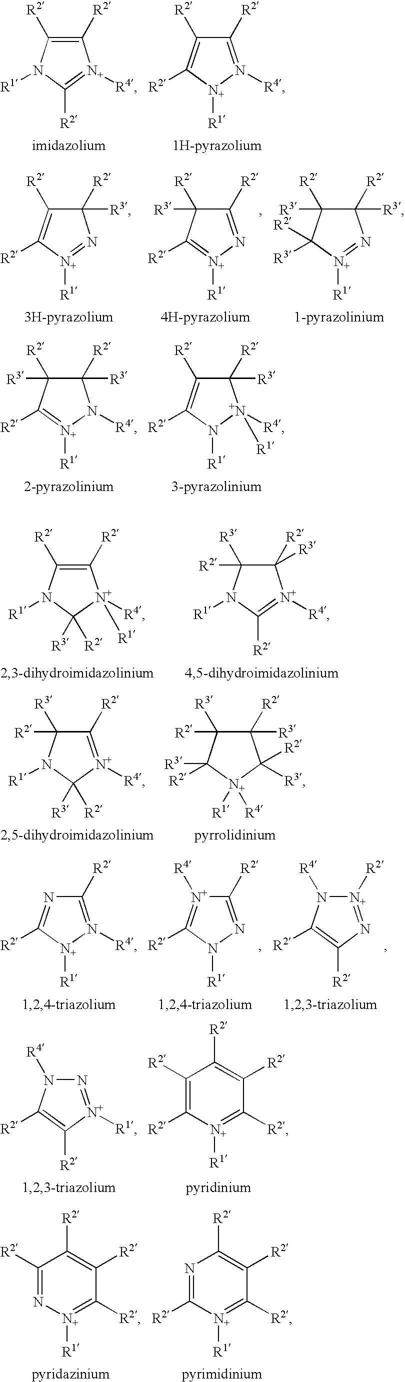

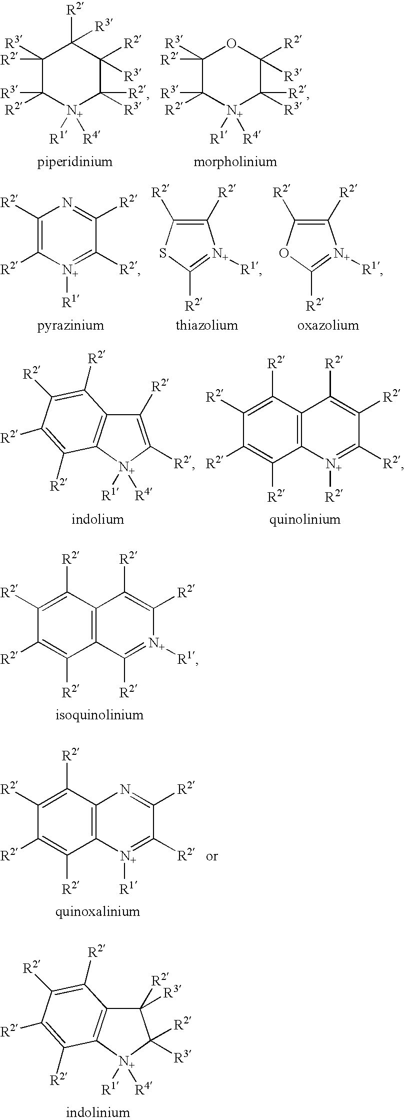

where the substituents
R¹′ to R⁴′ each, independently of one another, denote hydrogen, —CN, —OR′, —NR′₂, —P(O)R′₂, —P(O)(OR′)₂, —P(O)(NR′₂)₂, —C(O)R′, —C(O)OR′,
straight-chain or branched alkyl having 1-20 C atoms,
straight-chain or branched alkenyl having 2-20 C atoms and one or more double bonds,
straight-chain or branched alkynyl having 2-20 C atoms and one or more triple bonds,
saturated, partially or fully unsaturated cycloalkyl having 3-7 C atoms, which may be substituted by alkyl groups having 1-6 C atoms, saturated, partially or fully unsaturated heteroaryl, heteroaryl-C₁-C₆-alkyl or aryl-C₁-C₆-alkyl,
where the substituents R¹, R²′, R³′ and/or R⁴′ together may also form a ring system,
where one or more substituents R¹′ to R⁴′ may be partially or fully substituted by halogens, in particular —F and/or —Cl, or partially by —OH, —OR′, —CN, —C(O)OH, —C(O)NR′₂, —SO₂NR′₂, —C(O)X, —SO₂OH, —SO₂X, —NO₂, but where R^{1′} and R^{4′} cannot simultaneously be fully substituted by halogens,
and where, in the substituents R¹′ to R⁴′, one or two non-adjacent carbon atoms which are not bonded to the heteroatom may be replaced by atoms and/or atom groups selected from the group —O—, —S—, —S(O)—, —SO₂— or —P(O)R′—, where R′=non-, partially or perfluorinated C₁- to C₆-alkyl, C₃- to C₇-cycloalkyl, unsubstituted or substituted phenyl.

For the purposes of the present invention, fully unsaturated substituents are also taken to mean aromatic substituents.

Besides hydrogen, suitable substituents R and R¹ to R⁷ of the cations of the formulae (1) to (5) are preferably, in accordance with the invention: C₁- to C₂₀-, in particular C₁- to C₁₄-alkyl groups, and saturated or unsaturated, i.e. also aromatic, C₃- to C₇-cycloalkyl groups, which may be substituted by C₁- to C₆-alkyl groups, in particular phenyl.

The substituents R in the cations of the formula (1) or (2) may be identical or different here. The substituents R are preferably identical.

The substituent R is particularly preferably methyl, ethyl, isopropyl, propyl, butyl, sec-butyl, tert-butyl, pentyl, hexyl, octyl, decyl or tetradecyl.

Up to four substituents of the guanidinium cation [C(NR¹R²)(NR³R⁴)(NR⁵R⁶)]⁺ may also be connected in pairs in such a way that mono-, bi- or polycyclic cations are formed.

Without restricting generality, examples of such guanidinium cations are:

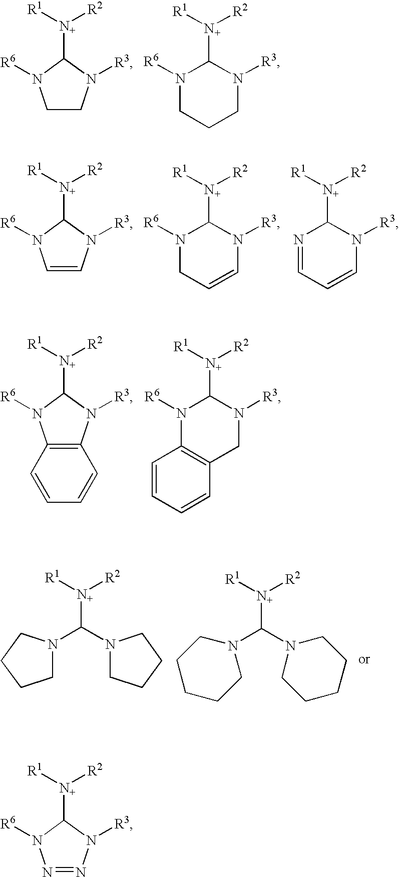

where the substituents R¹ to R³ and R⁶ may have an above-mentioned or particularly preferred meaning. The carbocycles or heterocycles of the above-mentioned guanidinium cations may optionally also be substituted by C₁- to C₆-alkyl, C₁- to C₆-alkenyl, NO₂, F, Cl, Br, I, OH, C₁-C₆-alkoxy, SCF₃, SO₂CF₃, COOH, SO₂NR″₂, SO₂X′ or SO₃H, where X′ and R″ have a meaning indicated above or below, substituted or unsubstituted phenyl or an unsubstituted or substituted heterocycle.

Up to four substituents of the uronium cation [(R¹R²N)—C(═OR⁷)(NR³R⁴)]⁺ or of the thiouronium cation [(R¹R²N)—C(═SR⁷)(NR³R⁴)]⁺ may also be connected in pairs in such a way that mono-, bi- or polycyclic cations are formed.

Without restricting generality, examples of such cations are indicated below, where Y=O or S:

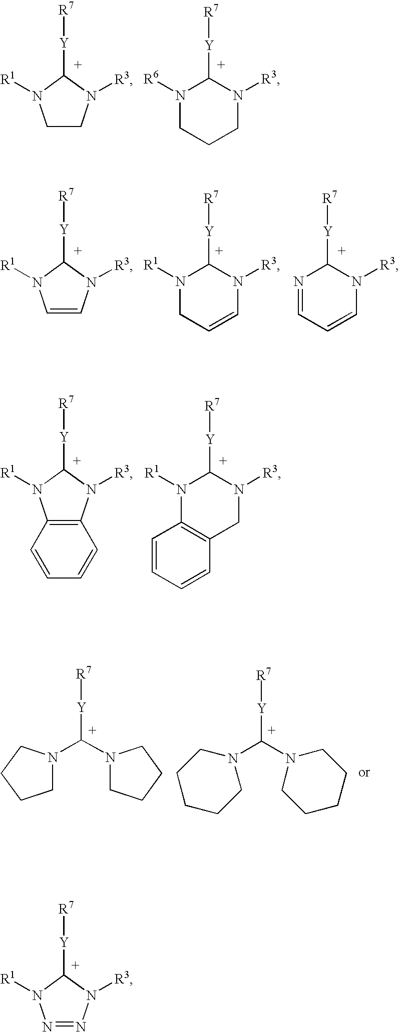

where the substituents R¹, R³ and R⁷ may have an above-mentioned or particularly preferred meaning. The carbocycles or heterocycles of the above-mentioned cations may optionally also be substituted by C₁- to C₆-alkyl, C₁- to C₆-alkenyl, NO₂, F, Cl, Br, I, OH, C₁-C₆-alkoxy, SCF₃, SO₂CF₃, COOH, SO₂NR″₂, SO₂X′ or SO₃H or substituted or unsubstituted phenyl or an unsubstituted or substituted heterocycle, where X′ and R″ have an above-mentioned meaning.

The substituents R¹ to R⁷ are each, independently of one another, preferably a straight-chain or branched alkyl group having 1 to 10 C atoms. The substituents R¹ and R², R³ and R⁴ and R⁵ and R⁶ in compounds of the formulae (3) to (5) may be identical or different here.

R¹ to R⁷ are particularly preferably each, independently of one another, methyl, ethyl, n-propyl, isopropyl, n-butyl, tert-butyl, sec-butyl, phenyl or cyclohexyl, very particularly preferably methyl, ethyl, n-propyl, isopropyl or n-butyl.

Besides hydrogen, suitable substituents R^{1′} to R^{4′} of cations of the formula (6) are preferably, in accordance with the invention: C₁- to C₂₀-, in particular C₁- to C₁₂-alkyl groups, and saturated or unsaturated, i.e. also aromatic, C₃- to C₇-cycloalkyl groups, which may be substituted by C₁- to C₆-alkyl groups, in particular phenyl.

The substituents R^{1′} and R^{4′} are each, independently of one another, particularly preferably methyl, ethyl, isopropyl, propyl, butyl, sec-butyl, tert-butyl, pentyl, hexyl, octyl, decyl, cyclohexyl, phenyl or benzyl. They are very particularly preferably methyl, ethyl, n-butyl or hexyl. In pyrrolidinium, piperidinium or indolinium compounds, the two substituents R^{1′} and R^{4′} are preferably different.

The substituent R^{2′} or R^{3′} is in each case, independently of one another, in particular, hydrogen, methyl, ethyl, isopropyl, propyl, butyl, sec-butyl, tert-butyl, cyclohexyl, phenyl or benzyl. R^{2′} is particularly preferably hydrogen, methyl, ethyl, isopropyl, propyl, butyl, sec-butyl or tert-butyl. R^{2′} and R^{3′} are very particularly preferably hydrogen.

The C₁-C₁₂-alkyl group is, for example, methyl, ethyl, isopropyl, propyl, butyl, sec-butyl or tert-butyl, furthermore also pentyl, 1-, 2- or 3-methylbutyl, 1,1-, 1,2- or 2,2-dimethylpropyl, 1-ethylpropyl, hexyl, heptyl, octyl, nonyl, decyl, undecyl or dodecyl. Optionally difluoromethyl, trifluoromethyl, pentafluoroethyl, heptafluoropropyl or nonafluorobutyl.

A straight-chain or branched alkenyl having 2 to 20 C atoms, where a plurality of double bonds may also be present, is, for example, allyl, 2- or 3-butenyl, isobutenyl, sec-butenyl, furthermore 4-pentenyl, isopentenyl, hexenyl, heptenyl, octenyl, —C₉H₁₇, —C₁₀H₁₉ to —C₂₀H₃₉; preferably allyl, 2- or 3-butenyl, isobutenyl, sec-butenyl, preference is furthermore given to 4-pentenyl, isopentenyl or hexenyl.

A straight-chain or branched alkynyl having 2 to 20 C atoms, where a plurality of triple bonds may also be present, is, for example, ethynyl, 1- or 2-propynyl, 2- or 3-butynyl, furthermore 4-pentynyl, 3-pentynyl, hexynyl, heptynyl, octynyl, —C₉H₁₅, —C₁₀H₁₇ to —C₂₀H₃₇, preferably ethynyl, 1- or 2-propynyl, 2- or 3-butynyl, 4-pentynyl, 3-pentynyl or hexynyl.

Aryl-C₁-C₆-alkyl denotes, for example, benzyl, phenylethyl, phenylpropyl, phenylbutyl, phenylpentyl or phenylhexyl, where both the phenyl ring and also the alkylene chain may be partially or fully substituted, as described above, by halogens, in particular —F and/or —Cl, or partially by —OH, —OR′, —CN, —C(O)OH, —C(O)NR′₂, —SO₂NR′₂, —C(O)X, —SO₂OH, —SO₂X, —NO₂.

Unsubstituted saturated or partially or fully unsaturated cycloalkyl groups having 3-7 C atoms are therefore cyclopropyl, cyclobutyl, cyclopentyl, cyclohexyl, cycloheptyl, cyclopentenyl, cyclopenta-1,3-dienyl, cyclohexenyl, cyclohexa-1,3-dienyl, cyclohexa-1,4-dienyl, phenyl, cycloheptenyl, cyclohepta-1,3-dienyl, cyclohepta-1,4-dienyl or cyclohepta-1,5-dienyl, each of which may be substituted by C₁- to C₆-alkyl groups, where the cycloalkyl group or the cycloalkyl group which is substituted by C₁- to C₆-alkyl groups may in turn also be substituted by halogen atoms, such as F, Cl, Br or I, in particular F or Cl, or by —OH, —OR′, —CN, —C(O)OH, —C(O)NR′₂, —SO₂NR′₂, —C(O)X, —SO₂OH, —SO₂X, NO₂.

In the substituents R, R¹ to R⁶ or R^{1′} to R^{4′}, one or two non-adjacent carbon atoms which are not bonded in the α-position to the heteroatom may also be replaced by atoms and/or atom groups selected from the group —O—, —S—, —S(O)—, —SO₂—, —SO₂O—, —C(O)—, —C(O)O—, —N⁺R′₂—, —P(O)R′O—, —C(O)NR′—, —SO₂NR′—, —OP(O)R′O—, —P(O)(NR′₂)NR′—, —PR′₂═N— or —P(O)R′—, where R′=non-, partially or perfluorinated C₁- to C₆-alkyl, C₃- to C₇-cycloalkyl, unsubstituted or substituted phenyl.

Without restricting generality, examples of substituents R, R¹ to R⁶ and R^{1′} to R^{4′} which have been modified in this way are:

—OCH₃, —OCH(CH₃)₂, —CH₂OCH₃, —CH₂—CH₂—O—CH₃, —C₂H₄OCH(CH₃)₂, —C₂H₄C₂H₅, —C₂H₄SCH(CH₃)₂, —S(O)CH₃, —SO₂CH₃, —SO₂C₆H₅, —SO₂C₃H₇, —SO₂CH(CH₃)₂, —SO₂CH₂CF₃, —CH₂SO₂CH₃, —O—C₄H₈—O—C₄H₉, —CF₃, —C₂F₅, —C₃F₇, —C₄F₉, —C(CF₃)₃, —CF₂SO₂CF₃, —C₂F₄N(C₂F₅)C₂F₅, —CHF₂, —CH₂CF₃, —C₂F₂H₃, —C₃H₆, —CH₂C₃F₇, —C(CFH₂)₃, —CH₂C(O)OH, —CH₂C₆H₅, —C(O)C₆H₅ or P(O)(C₂H₅)₂.

In R′, C₃- to C₇-cycloalkyl is, for example, cyclopropyl, cyclobutyl, cyclopentyl, cyclohexyl or cycloheptyl.

In R′, substituted phenyl denotes phenyl which is substituted by C₁- to C₆-alkyl, C₁- to C₆-alkenyl, NO₂, F, Cl, Br, I, OH, C₁-C₆-alkoxy, SCF₃, SO₂CF₃, COOH, SO₂X′, SO₂NR₁₂ or SO₃H, where X′ denotes F, Cl or Br and R″ denotes a non-, partially or perfluorinated C₁- to C₆-alkyl or C₃- to C₇-cycloalkyl, as defined for R′, for example o-, m- or p-methylphenyl, o-, m- or p-ethylphenyl, o-, m- or p-propylphenyl, o-, m- or p-isopropylphenyl, o-, m- or p-tert-butylphenyl, o-, m- or p-nitrophenyl, o-, m- or p-hydroxyphenyl, o-, m- or p-methoxyphenyl, o-, m- or p-ethoxyphenyl, o-, m-, p-(trifluoromethyl)phenyl, o-, m-, p-(trifluoromethoxy)phenyl, o-, m-, p-(trifluoromethylsulfonyl)phenyl, o-, m- or p-fluorophenyl, o-, m- or p-chlorophenyl, o-, m- or p-bromophenyl, o-, m- or p-iodophenyl, furthermore preferably 2,3-, 2,4-, 2,5-, 2,6-, 3,4- or 3,5-dimethylphenyl, 2,3-, 2,4-, 2,5-, 2,6-, 3,4- or 3,5-dihydroxyphenyl, 2,3-, 2,4-, 2,5-, 2,6-, 3,4- or 3,5-difluorophenyl, 2,3-, 2,4-, 2,5-, 2,6-, 3,4- or 3,5-dichlorophenyl, 2,3-, 2,4-, 2,5-, 2,6-, 3,4- or 3,5-dibromophenyl, 2,3-, 2,4-, 2,5-, 2,6-, 3,4- or 3,5-dimethoxyphenyl, 5-fluoro-2-methylphenyl, 3,4,5-trimethoxyphenyl or 2,4,5-trimethylphenyl.

In R^{1′} to R^{4′}, heteroaryl is taken to mean a saturated or unsaturated mono- or bicyclic heterocyclic radical having 5 to 13 ring members, in which 1, 2 or 3 N and/or 1 or 2 S or O atoms may be present and the heterocyclic radical may be mono- or polysubstituted by C₁- to C₆-alkyl, C₁- to C₆-alkenyl, NO₂, F, Cl, Br, I, OH, C₁-C₆-alkoxy, SCF₃, SO₂CF₃, COOH, SO₂X′, SO₂NR″₂ or SO₃H, where X′ and R″ have an above-mentioned meaning.

The heterocyclic radical is preferably substituted or unsubstituted 2- or 3-furyl, 2- or 3-thienyl, 1-, 2- or 3-pyrrolyl, 1-, 2-, 4- or 5-imidazolyl, 3-, 4- or 5-pyrazolyl, 2-, 4- or 5-oxazolyl, 3-, 4- or 5-isoxazolyl, 2-, 4- or 5-thiazolyl, 3-, 4- or 5-isothiazolyl, 2-, 3- or 4-pyridyl, 2-, 4-, 5- or 6-pyrimidinyl, furthermore preferably 1,2,3-triazol-1-, -4- or -5-yl, 1,2,4-triazol-1-, -4- or -5-yl, 1- or 5-tetrazolyl, 1,2,3-oxadiazol-4- or -5-yl, 1,2,4-oxadiazol-3- or -5-yl, 1,3,4-thiadiazol-2- or -5-yl, 1,2,4-thiadiazol-3- or -5-yl, 1,2,3-thiadiazol-4- or -5-yl, 2-, 3-, 4-, 5- or 6-2H-thiopyranyl, 2-, 3- or 4-4H-thiopyranyl, 3- or 4-pyridazinyl, pyrazinyl, 2-, 3-, 4-, 5-, 6- or 7-benzofuryl, 2-, 3-, 4-, 5-, 6- or 7-benzothienyl, 1-, 2-, 3-, 4-, 5-, 6- or 7-1H-indolyl, 1-, 2-, 4- or 5-benzimidazolyl, 1-, 3-, 4-, 5-, 6- or 7-benzopyrazolyl, 2-, 4-, 5-, 6- or 7-benzoxazolyl, 3-, 4-, 5-, 6- or 7-benzisoxazolyl, 2-, 4-, 5-, 6- or 7-benzothiazolyl, 2-, 4-, 5-, 6- or 7-benzisothiazolyl, 4-, 5-, 6- or 7-benz-2,1,3-oxadiazolyl, 1-, 2-, 3-, 4-, 5-, 6-, 7- or 8-quinolinyl, 1-, 3-, 4-, 5-, 6-, 7- or 8-isoquinolinyl, 1-, 2-, 3-, 4- or 9-carbazolyl, 1-, 2-, 3-, 4-, 5-, 6-, 7-, 8- or 9-acridinyl, 3-, 4-, 5-, 6-, 7- or 8-cinnolinyl, 2-, 4-, 5-, 6-, 7- or 8-quinazolinyl or 1-, 2- or 3-pyrrolidinyl.

Analogously to aryl-C₁-C₆-alkyl, heteroaryl-C₁-C₆-alkyl is taken to mean, for example, pyridinylmethyl, pyridinylethyl, pyridinylpropyl, pyridinylbutyl, pyridinylpentyl, pyridinylhexyl, where the above-described heterocycles may furthermore be linked to the alkylene chain in this manner.

HetN⁺ is preferably

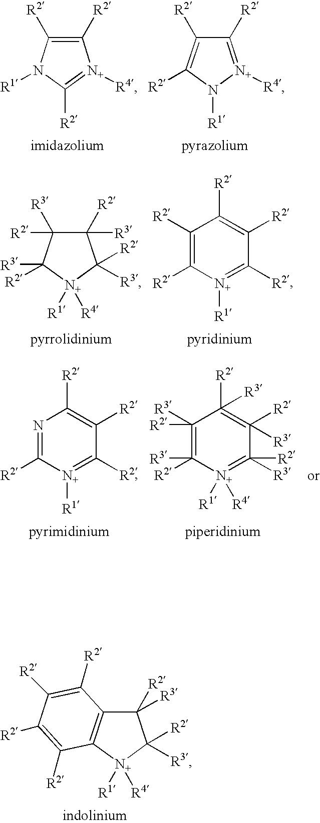

where the substituents R^{1′} to R^{4′} each, independently of one another, have a meaning described above.

HetN⁺ is particularly preferably imidazolium, pyrrolidinium or pyridinium, as defined above, where the substituents R^{1′} to R^{4′} each, independently of one another, have a meaning described above. HetN⁺ is very particularly preferably imidazolium, where the substituents R^{1′} to R^{4′} each, independently of one another, have a meaning described above.

Further examples of suitable anions are:

[R¹SO₃]⁻, [R^{F′}SO₃]⁻, [(FSO₂)₂N]⁻, [(R^{F}SO₂)₂N]⁻, [(R^{F}SO₂)₃C]⁻, [(FSO₂)₃C]⁻, [R¹CH₂OSO₃]⁻, [R¹C(O)O]⁻, [R^{F′}C(O)O]⁻, [CCl₃C(O)O]⁻, [(CN)₃C]⁻, [(CN)₂CR¹]⁻, [(R¹O(O)C)₂CR¹]⁻, [P(CₙF₂ₙ₊₁₋ₘHₘ)_{y}F_{6-y}]⁻, [P(C₆F₅)_{y}F_{6-y}]⁻, [R¹₂P(O)O]⁻, [R¹P(O)O₂]²⁻, [(R¹O)₂P(O)O]⁻, [(R¹O)P(O)O₂]²⁻, [(R¹O)(R¹)P(O)O]⁻, [R^{F}₂P(O)O]⁻, [R^{F}P(O)O₂]²⁻, [BF_{z}R^{F}_{4-z}]⁻, [BF_{z}(CN)_{4-z}]⁻, [B(CN)₄]⁻, [B(C₆F₅)₄]⁻, [B(OR¹)₄]⁻, [N(CF₃)₂]⁻, [N(CN)₂]⁻, [AlCl₄]⁻ or [SiF₆]²⁻,
where the substituents R^{F} and R^{F′} each, independently of one another, have the meaning of
perfluorinated and straight-chain or branched alkyl having 1-20 C atoms,
perfluorinated and straight-chain or branched alkenyl having 2-20 C atoms and one or more double bonds,
perfluorinated phenyl and saturated, partially or fully unsaturated cycloalkyl having 3-7 C atoms, which may be substituted by perfluoroalkyl groups, where the substituents R^{F} or R^{F′} may be connected to one another in pairs by a single or double bond and
where one carbon atom or two non-adjacent carbon atoms of the substituent R^{F} or R^{F′} which are not in the α-position to the heteroatom may be replaced by atoms and/or atom groups selected from the group —O—, —C(O)—, —S—, —S(O)—, —SO₂—, —N═, —N═N—, —NR′—, —PR′— and —P(O)R′— or may have an end group R′—O—SO₂— or R′—O—C(O)—, where R′ denotes non-fluorinated, partially or perfluorinated alkyl having 1-6 C atoms, saturated or partially unsaturated cycloalkyl having 3-7 C atoms, unsubstituted or substituted phenyl or an unsubstituted or substituted heterocycle,
and
where the substituents R¹ each, independently of one another, have the meaning of
hydrogen in the case where A⁻=[(CN)₂CR¹]⁻ or [(R¹O(O)C)₂CR¹]⁻ and X=O or S, or
hydrogen in the case where A⁻=[R¹CH₂OSO₃]⁻, X=S or O and the substituents R and R⁰=alkyl groups having 1 to 20 C atoms,
straight-chain or branched alkyl having 1-20 C atoms,
straight-chain or branched alkenyl having 2-20 C atoms and one or more double bonds,
straight-chain or branched alkynyl having 2-20 C atoms and one or more triple bonds,
saturated, partially or fully unsaturated cycloalkyl having 3-7 C atoms,
which may be substituted by alkyl groups having 1-6 C atoms,
where the substituents R¹ may be partially substituted by CN, NO₂ or halogen, and
halogen denotes F, Cl, Br or I,
where the substituents R¹ may be connected to one another in pairs by a single or double bond, and
where one carbon atom or two non-adjacent carbon atoms of the substituent R¹ which are not in the α-position to the heteroatom may be replaced by atoms and/or atom groups selected from the group —O—, —C(O)—, —C(O)O—, —S—, —S(O)—, —SO₂—, —SO₃—, —N═, —N═N—, —NH—, —NR′—, —PR′— and —P(O)R′—, —P(O)R′O—, OP(O)R′O—, —PR′₂═N—, —C(O)NH—, —C(O)NR′—, —SO₂NH— or —SO₂NR′—, where R′ denotes non-fluorinated, partially or perfluorinated alkyl having 1-6 C atoms, saturated or partially unsaturated cycloalkyl having 3-7 C atoms, unsubstituted or substituted phenyl or an unsubstituted or substituted heterocycle,
and the variables
n denotes 1 to 20,
m denotes 0, 1, 2 or 3,
y denotes 0, 1, 2, 3 or 4,
z denotes 0, 1, 2 or 3.

A straight-chain or branched alkenyl having 2 to 20 C atoms, where, in addition, a plurality of double bonds may be present, is, for example, allyl, 2- or 3-butenyl, isobutenyl, sec-butenyl, furthermore 4-pentenyl, isopentenyl, hexenyl, heptenyl, octenyl, —C₉H₁₇, —C₁₀H₁₉ to —C₂₀H₃₉; preferably allyl, 2- or 3-butenyl, isobutenyl, sec-butenyl, preference is furthermore given to 4-pentenyl, isopentenyl or hexenyl.

A straight-chain or branched alkynyl having 2 to 20 C atoms, where a plurality of triple bonds may also be present, is, for example, ethynyl, 1- or 2-propynyl, 2- or 3-butynyl, furthermore 4-pentynyl, 3-pentynyl, hexynyl, heptynyl, octynyl, —C₉H₁₅, —C₁₀H₁₇ to —C₂₀H₃₇, preferably ethynyl, 1- or 2-propynyl, 2- or 3-butynyl, 4-pentynyl, 3-pentynyl or hexynyl.

In the case where a plurality of R^{F} or R^{F′} are present in an anion, these may also be connected in pairs by single or double bonds in such a way that bi- or polycyclic anions are formed.

Furthermore, the substituents R^{F} or R^{F′} may contain one or two atoms or atom groups selected from the group —O—, —SO₂— and —NR′— which are not adjacent to one another and are not in the α-position to the heteroatom or may contain the end group —SO₂X′, where R′=non-, partially or perfluorinated C₁- to C₆-alkyl, C₃- to C₇-cycloalkyl, unsubstituted or substituted phenyl, including —C₆F₅, or an unsubstituted or substituted heterocycle, and X′=F, Cl or Br.

Without restricting generality, examples of substituents R^{F} and R^{F′} of the anion are:

—CF₃, —C₂F₅, —C₃F₇, —C₄F₉, —C(CF₃)₃, —CF₂N(CF₃)CF₃, —CF₂OCF₃, —CF₂S(O)CF₃, —CF₂SO₂CF₃, —C₂F₄N(C₂F₅)C₂F₅, CF═CF₂, —C(CF₃)═CFCF₃, —CF₂CF═CFCF₃, —CF═CFN(CF₃)CF₃ or —CF₂SO₂F, —C(CF₃)═CFCF₃, —CF₂CF═CFCF₃ or —CF═CFN(CF₃)CF₃.

R^{F′} is preferably pentafluoroethyl, heptafluoropropyl or nonafluorobutyl. R^{F} is preferably trifluoromethyl, pentafluoroethyl, heptafluoropropyl or nonafluorobutyl.

Some examples of suitable anions are indicated below:

[CF₃SO₃]⁻, [CF₃CF₂SO₃]⁻, [CH₃CH₂SO₃]⁻, [(CF₃SO₂)₂N]⁻, [(C₂F₅SO₂)₂N]⁻, [(CF₃SO₂)₃C]⁻, [(C₂F₅SO₂)₃C]⁻, [CH₃CH₂OSO₃]⁻, [(FSO₂)₃C]⁻, [CF₃C(O)O]⁻, [CF₃CF₂C(O)O]⁻, [CH₃CH₂C(O)O]⁻, [CH₃C(O)O]⁻, [P(C₂F₅)₃F₃]⁻, [P(CF₃)₃F₃]⁻, [P(C₂F₄H)(CF₃)₂F₃]⁻, [P(C₂F₃H₂)₃F₃]⁻, [P(C₂F₅)(CF₃)₂F₃]⁻, [P(C₆F₅)₃F₃]⁻, [P(C₃F₇)₃F₃]⁻, [P(C₄F₉)₃F₃]⁻, [P(C₂F₅)₂F₄]⁻, [(C₂F₅)₂P(O)O]⁻, [(C₂F₅)P(O)O₂]²⁻, [P(C₆F₅)₂F₄]⁻, [(CF₃)₂P(O)O]⁻, [(CH₃)₂P(O)O]⁻, [(C₄F₉)₂P(O)O]⁻, [CF₃P(O)O₂]²⁻, [CH₃P(O)O₂]²⁻, [(CH₃O)₂P(O)O]⁻, [BF₃(CF₃)]⁻, [BF₂(C₂F₅)₂]⁻, [BF₃(C₂F₅)]⁻, [BF₂(CF₃)₂]⁻, [B(C₂F₅)₄]⁻, [BF₃(CN)]⁻, [BF₂(CN)₂]⁻, [B(CN)₄]⁻, [B(CF₃)₄]⁻, [BF₄]⁻, [B(OCH₃)₄]⁻, [B(OCH₃)₂(OC₂H₅)]⁻, [B(O₂C₂H₄)₂]⁻, [B(O₂C₂H₂)₂]⁻, [B(O₂CH₄)₂]⁻, [N(CF₃)₂]⁻, [N(CN₂)₂]⁻, [C(CN)₃]⁻, [AlCl₄]⁻ or [SiF₆]²⁻.

Other suitable anions are borates of the formula (7)

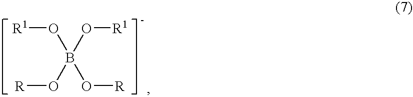

in which R and R¹ are identical or different,
are optionally connected directly to one another by a single or double bond, each, individually or together, have the meaning of an aromatic ring from the group phenyl, naphthyl, anthracenyl or phenanthrenyl, which may be unsubstituted or mono- to tetrasubstituted by A or Hal,
or
each, individually or together, have the meaning of a heterocyclic aromatic ring from the group
pyridyl, which may be unsubstituted or mono- to trisubstituted by A or Hal, and
Hal denotes F or Cl
and
A denotes alkyl having 1 to 6 C atoms, which may be mono- to tetrahalogenated.

In particular, the borates are selected from compounds of the formula (8)

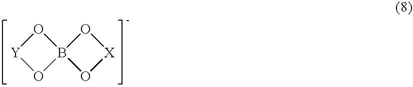

where —X— and —Y— each, identically or differently, denote —C(O)—C(O)—, —C(O)—(CH₂)_{q}—C(O)—, where q=1, 2 or 3, —C(O)—(CF₂)_{q}—C(O)—, where q=1, 2 or 3, —C(CF₃)₂—C(CF₃)₂—,

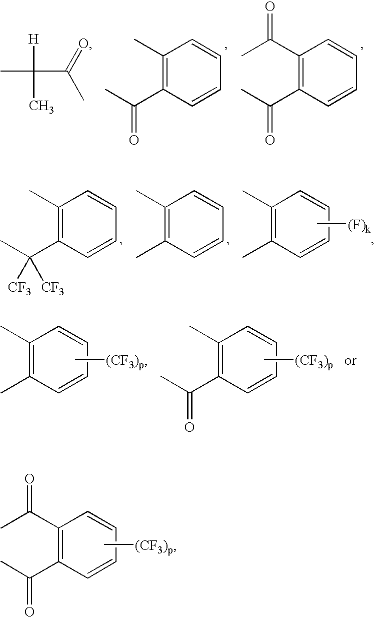

where k=1, 2, 3 or 4 and p=1 or 2.

The properties of ionic liquids, for example melting point, thermal and electrochemical stability, viscosity, are strongly influenced by the nature of the anion. By contrast, the polarity and hydrophilicity or hydrophobicity can be varied through a suitable choice of the cation/anion pair. Preference is given in accordance with the invention to the use of hydrophobic ionic liquids. A person skilled in the art in the area of ionic liquids is able to produce ionic liquids having a hydrophobic character, if desired with the aid of the anions and cations listed above. Ionic liquids having a large number of fluorine atoms frequently exhibit a somewhat hydrophobic character. Examples of suitable fluorinated anions are bis(trifluoromethanesulfon)imide or trifluorotris(pentafluoroethyl)phosphate anions.

Examples of hydrophobic ionic liquids are: 1-hexyl-3-methylimidazolium tris(pentafluoroethyl)trifluorophosphate, 1-butyl-1-methylpyrrolidinium tris(pentafluoroethyl)trifluorophosphate, 1-butyl-1-methylpyrrolidinium bis(trifluoromethylsulfonyl)imide and 1-butyl-3-methylimidazolium hexafluorophosphate. An ionic liquid which is particularly preferred in accordance with the invention is 1-hexyl-3-methylimidazolium bis(trifluoromethylsulfonyl)imide.

In some cases, the use of basic ionic liquids may also be advantageous since the hydrolysis of silanes and thus reaction thereof takes place particularly well in a basic medium.

The process according to the invention comprises at least the following reaction steps
a) provision of a solid support material
b) reaction of the solid support material with silanes in the presence of ionic liquid
c) separation of the support material
d) optionally washing and drying of the support material.

The reagents employed in the process according to the invention and the concentrations thereof correspond to those from the prior art, apart from the replacement of the known solvents by ionic liquids. No adaptations are generally necessary either with respect to carrying out the reaction. In the case of di- or trifunctional silanes, the silane concentrations are typically selected so that the surface modification is substantially crosslinked, but the layer thickness forms a monolayer. Besides the frequently better chromatographic selectivity, the advantage of this crosslinking lies in the chemical stability of a surface modification of this type. However, the formation of multilayers is also possible.

In the case of silica gel materials, the number of surface SiOH groups is about 8 μmol/m². Accordingly, the amount of silanes employed should be selected to be at least so large that sufficient silane is available to react all SiOH groups. However, it must be taken into account that typically not all SiOH groups do actually react. Coverage densities between 4 and 6 μmol/m² can typically be achieved in the case of monolayers. Otherwise, a multilayer must be selected.

Typically, the support material is firstly wetted as completely as possible with the solvent, i.e. the ionic liquid. The silane is then added slowly with stirring or shaking and usually left to react for a period of 1 to 24 hours, preferably 3 to 8 hours. When the reaction is complete, the mixture is generally allowed to cool, and the support material is then separated off, for example by filtration or simple decantation of the solvent. The support material is preferably subsequently washed with organic solvents, such as, for example, heptane or toluene, and dried, for example, in vacuo.

Catalysts or stabilisers, as are also known for the silanisation of support materials in the presence of conventional solvents, may optionally be added to the reaction mixture.

In a preferred embodiment, the reaction is carried out in the presence of ionic liquid which remains stable over the duration of the reaction at temperatures up to 300° C., preferably up to 350-450° C. In this way, it is possible to carry out the silanisation at temperatures between 150 and 450° C., preferably between 200 and 400° C. Such temperatures can only be achieved with difficulty using conventional organic solvents. Due to this advantage, the silanisation according to the invention frequently proceeds more quickly than by conventional processes.

The process according to the invention can be carried out in through-flow in the case of ready-packed columns. Otherwise, the reaction vessels or pressure autoclaves which are usual for surface modifications are used.

The silanisation according to the invention is preferably carried out under protective gas, i.e., in particular, oxygen-free. Furthermore, in order to avoid side reactions, it should be ensured that all reagents are anhydrous.

In a preferred embodiment, the alcohol (typically methanol or ethanol) liberated during the silanisation in the case of the use of alkoxysilanes is removed from the reaction mixture, for example with the aid of a distillation bridge, in order to shift the reaction equilibrium towards the product side.

It has furthermore been found that the process according to the invention in the presence of ionic liquids as solvent is particularly suitable for the surface modification of monolithic mouldings. In the case of the use of conventional solvents, it is thought that the vapour pressure of the solvents repeatedly causes partial destruction of the filigrane structures in the interior of the moulding. This can be avoided virtually completely through the use of ionic liquids instead of conventional solvents. It has furthermore been found that monolithic mouldings are modified particularly uniformly in their entirety, in particular over their entire cross section, by the process according to the invention.

In an embodiment, a support material which has already been surface-modified once by the process according to the invention or by conventional processes, i.e. already carries separation effectors, is employed in step a). In this case, the reaction according to the invention serves for end capping. End capping is carried out in order to derivatise unreacted reactive groups of the support material, i.e. to react them with short-chain silanes in a second silanisation step.

The sorbents prepared by the process according to the invention exhibit very good separation properties, even without end capping, meaning that end capping is generally not absolutely necessary in this case.

In a further embodiment, a further modification step can be carried out after the surface modification according to the invention using silanes. In general, use is made here of a reagent which is able to react with the silanes that have already been introduced. Depending on the silane introduced and the reagent used in the second step, amide or ester bonds, for example, can be formed. In a preferred embodiment, a polymer layer is formed in the second modification step. To this end, a silane which contains a polymerisable group, typically a polymerisable double bond, such as, for example, a vinylsilane, is firstly introduced by the process according to the invention. In the second modification step, a polymer layer comprising monomers whose reaction can be initiated, for example, thermally, chemically or by exposure to light is then formed. Suitable organic polymers are, for example, polystyrenes, polymethacrylates, melamines, polysaccharides, polysiloxanes and derivatives thereof or copolymers of two or more suitable compounds. Also suitable are copolymers of the above-mentioned substances with monomers which already carry separation effectors which are suitable for chromatography, such as, for example, copolymers of polystyrenes with compounds which carry ion-exchanger groups. Preference is given to polystyrenes or polystyrene derivatives, particularly preferably polymethacrylates or polymethacrylate derivatives, in particular poly(methacrylate), poly(2-hydroxyethyl methacrylate), a copolymer of 2-hydroxyethyl methacrylate and ethyl methacrylate, or poly(octadecyl methacrylate).

It has been found that the production of a polymer layer is also advantageously carried out in the presence of ionic liquid. Otherwise, the usual reaction conditions can be selected.

The surface-modified support materials for chromatography prepared by the process according to the invention are distinguished by good separation efficiency, for example in the chromatography of basic compounds. Tailing drops considerably.

In addition, the process according to the invention offers a considerable simplification when carrying out the experiment: due to the low vapour pressure of the ionic liquids, complex pressure apparatus are usually unnecessary. In addition, many safety problems can be avoided, in spite of the high reaction temperatures, since ionic liquids are generally inert and, unlike many organic solvents, have a flash point below 400° C.

Even without further comments, it is assumed that a person skilled in the art will be able to utilise the above description in the broadest scope. The preferred embodiments and examples should therefore merely be regarded as descriptive disclosure which is absolutely not limiting in any way.

The complete disclosure content of all applications, patents and publications mentioned above and below, in particular the corresponding application DE 10 2005 031 166.0, filed on Apr. 7, 2005, is incorporated into this application by way of reference.

### EXAMPLES

In the following examples, the degree of crosslinking is determined by means of solid-state NMR (especially ²⁹Si-NMR). The comment “poor crosslinking” here means that degrees of crosslinking of at most 50-60% are achieved. “Moderate crosslinking” means that about 60-80% crosslinking is achieved. “Good crosslinking” is present at a degree of crosslinking of greater than 80%.

In the ²⁹Si-NMR, the degree of crosslinking, i.e. the number of residual silanol groups (reactive groups on the silica gel surface), can be recognised from the signals of the surface modification. The resonances which occur at about 0 to −20 ppm (difunctionally bonded modification) and −90 to −120 ppm (silanol/siloxane bulk) can, as described in the literature, be assigned to the corresponding structural components. The worse the crosslinking of the surface modification, the higher the signal at about −5 ppm. The height of this signal corresponds to the amount of residual silanol groups present whose NMR resonance signal is to be found at about −100 ppm. In the case of good crosslinking of the surface modification, the corresponding signal at about −20 ppm is significantly pronounced and the signal at −5 ppm is virtually undetectable. For this reason, the reactive silanol groups (resonance at about −100 ppm) are then also significantly reduced and only evident as a slight shoulder in the resonance peak of the siloxanes of the bulk material.

In order to investigate the chromatographic properties of the materials, the separation properties thereof in the separation of procainamides or triptylines were investigated.

### Chromatographic Conditions:

a) Separation of procainamides (3.6 mg/100 ml) and N-acetylprocainamide (2.1 mg/100 ml)
   Eluent: methanol/0.02 M NaH₂PO₄ with NaOH, pH 7.6 (30/70)
   Flow rate: 1 ml/min

### Detection: UV 254 nm

Room temperature
Injection volume: 10 μl
b) Separation of imipramine (26.1 mg/100 ml) and amitriptyline (28.1 mg/100 ml)
   Eluent: methanol/0.02 M NaH₂PO₄ with NaOH, pH 7.6 (30/70)
   Flow rate: 1 ml/min

### Detection: UV 254 nm

Room temperature
Injection volume: 10 μl

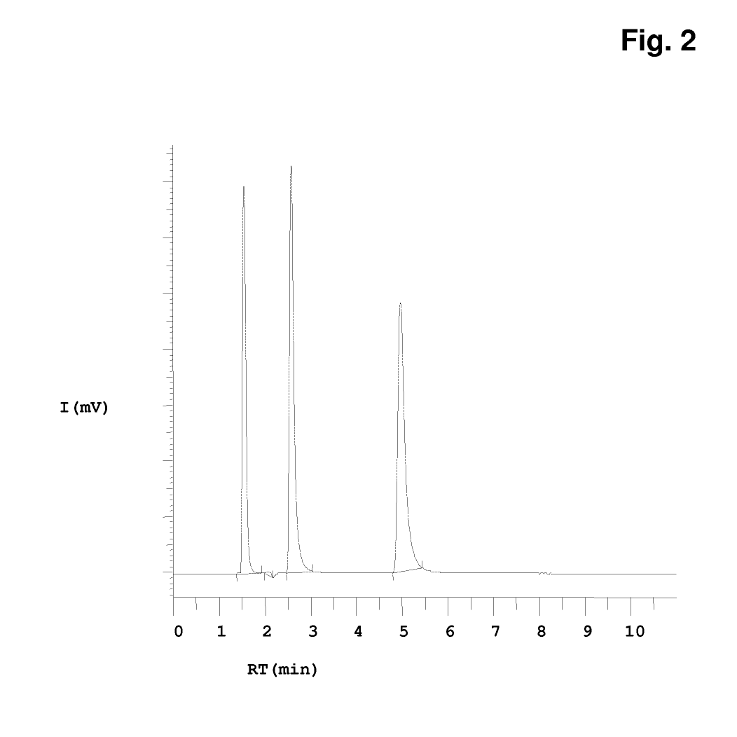

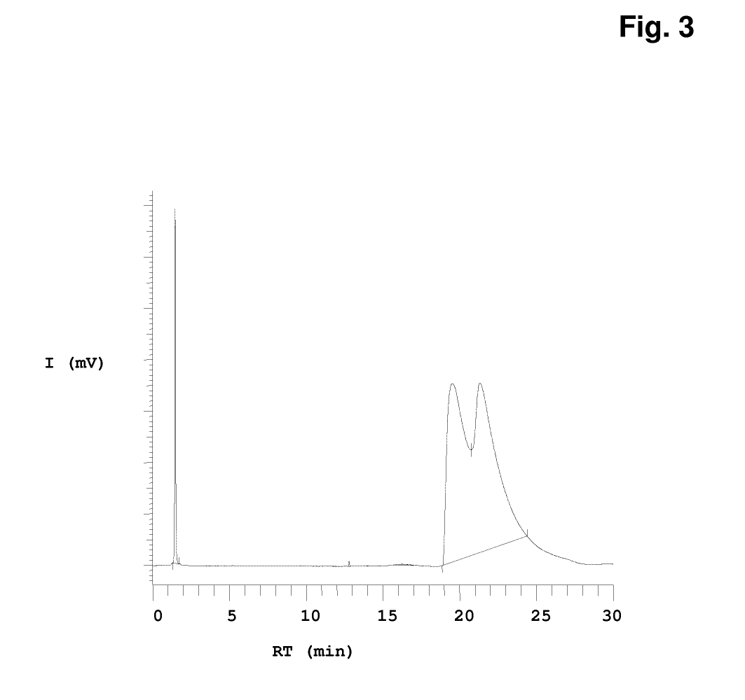

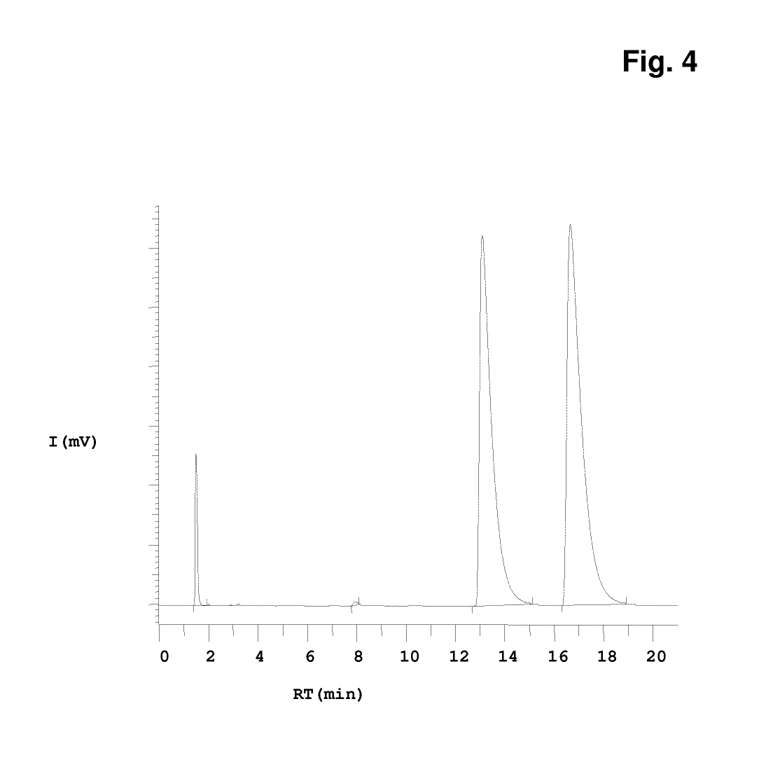

FIGS. 1 to 4 show illustrative chromatograms obtained in the separation of procainamides or triptylines. The labelling of the ordinate (I) here stands for intensity, the labelling of the abscissa (RT) stands for retention time. FIG. 1 shows poor separation, FIG. 2 shows good separation of the procainamides. FIG. 3 shows poor separation, FIG. 4 shows good separation of the triptylines.

1. Reactions in Accordance with the Prior Art on Particulate Materials

### 1.1 Surface Modification of Silica Particles in Toluene (Boiling Point at About 110.6° C.)

50 g of Purospher® Si 5 μm particles having a specific surface area of 320 m²/g are dried for four hours at 100° C. in vacuo. After cooling to room temperature, the material is suspended in 250 ml of toluene under protective gas and with stirring. For the surface modification, a mixture of 57.4 g of octadecylmethyldimethoxysilane (MW 358.68 g/mol) (10 μmol/m²) in 50 ml of toluene is added dropwise to the suspension over the course of 30 minutes. The reaction mixture is subsequently boiled under reflux (bath temperature 120° C.) for 5 hours with stirring and under protective gas. After the reaction mixture has cooled, the silica gel material is filtered off with suction and rinsed with 3×200 ml of toluene. After the silica gel material has been dried for 4 hours in vacuo, the elemental analysis showed a carbon value of 18.0%, which means a surface coverage of 3.22 μmol/m².

### 1.2 Surface Modification of Silica Particles in Toluene Using a Distillation Bridge in Order to Shift the Equilibrium.

50 g of Purospher® Si 5 μm particles having a specific surface area of 320 m²/g are dried for four hours at 100° C. in vacuo. After cooling to room temperature, the material is suspended in 250 ml of toluene under protective gas and with stirring. For the surface modification, a mixture of 57.4 g of octadecylmethyldimethoxysilane (10 μmol/m²) in 50 ml of toluene is added dropwise to the suspension over the course of 30 minutes. The reaction mixture is subsequently left to react for 5 hours at a bath temperature of 110° C. with stirring and under protective gas. In order to shift the reaction equilibrium, the methanol formed is removed from the reaction mixture with the aid of a distillation bridge.

After the reaction mixture has cooled, the silica gel material is filtered off with suction and rinsed with 3×200 ml of toluene. After the silica gel material has been dried for 4 hours in vacuo, the elemental analysis shows a carbon value of C=18.8%, which means a surface coverage of about 3.41 μmol/m².

### 1.3 Surface Modification of Silica Particles in Toluene Using a Distillation Bridge in Order to Shift the Equilibrium.

50 g of Purospher® Si 5 μm particles having a specific surface area of 320 m²/g are dried for four hours at 100° C. in vacuo. After cooling to room temperature, the material is suspended in 250 ml of toluene under protective gas and with stirring. For the surface modification, a mixture of 172.2 g of octadecylmethyldimethoxysilane (30 μmol/m²) in 150 ml of toluene is added dropwise to the suspension over the course of 30 minutes. The reaction mixture is subsequently left to react for 5 hours at a bath temperature of 110° C. with stirring and under protective gas. In order to shift the reaction equilibrium, the methanol formed is removed from the reaction mixture with the aid of a distillation bridge.

After the reaction mixture has cooled, the silica gel material is filtered off with suction and rinsed with 3×200 ml of toluene. After the silica gel material has been dried for 4 hours in vacuo, the elemental analysis shows a carbon value of C=18.8%, which means a surface coverage of about 3.41 μmol/m².

The NMR investigation shows poor crosslinking.

Chromatography: poor separation

1.4 End Capping of the Material from Experiment No. 1.3 Using HMDS

10 g of Purospher® RP-18 5 μm particles from Experiment 1.3 are dried for four hours at 100° C. in vacuo. After cooling to room temperature, the material is suspended in 50 ml of toluene under protective gas and with stirring. For the end capping, 5 ml of hexamethyldisilazane (HMDS) are added dropwise to the suspension over the course of 10 minutes.

The reaction mixture is subsequently left to react for 5 hours at a bath temperature of 120° C. with stirring and under protective gas.

After the reaction mixture has cooled, the silica gel material is filtered off with suction and rinsed with 3×50 ml of toluene. After the silica gel material has been dried for 4 hours in vacuo, the elemental analysis shows a carbon value of C=19.2%, which means a surface coverage of about 3.76 μmol/m².

NMR: no improvement in the crosslinking compared with Experiment 1.3.

1.5 End Capping of the Material from Experiment No. 1.3 Using Dimethyldichlorosilane

10 g of Purospher® RP-18 5 μm particles from Experiment 1.3 are dried for four hours at 100° C. in vacuo. After cooling to room temperature, the material is suspended in 50 ml of toluene under protective gas and with stirring. For the end capping, 5 ml of dimethyldichlorosilane are added dropwise to the suspension over the course of 10 minutes.

The reaction mixture is subsequently left to react for 5 hours at a bath temperature of 120° C. with stirring and under protective gas.

After the reaction mixture has cooled, the silica gel material is filtered off with suction and rinsed with 3×50 ml of toluene. After the silica gel material has been dried for 4 hours in vacuo, the elemental analysis shows a carbon value of C=19.1%, which means a surface coverage of about 3.80 μmol/m².

NMR: no improvement in the crosslinking compared with Experiment 1.3.

2. Surface Modifications on Particulate Materials Carried Out in Accordance with the Invention

### 2.1 Experimental Procedure Corresponding to Experiment 1.2.

10 g of Purospher® Si 5 μm particles having a specific surface area of 320 m²/g are dried for four hours at 100° C. in vacuo. After cooling to room temperature, the material is suspended in 40 ml of 1-hexyl-3-methylimidazolium bis(trifluoromethylsulfonyl)imide under protective gas and with stirring. For the surface modification, 11.5 g of octadecylmethyldimethoxysilane (10 μmol/m²) are added dropwise to the suspension over the course of 30 minutes. The reaction mixture is subsequently stirred at a bath temperature of 120° C. for 5 hours under protective gas. After the reaction mixture has cooled, the silica gel material is filtered off with suction and rinsed with 3×100 ml of toluene. After the silica gel material has been dried for 4 hours in vacuo, the elemental analysis shows a carbon value of C=19.0%, which means a surface coverage of about 3.45 μmol/m².

### 2.2. End Capping Using Dimethylchlorosilane

5 g of Purospher® RP-18 5 μm particles from Experiment 2.1 are dried for four hours at 100° C. in vacuo. After cooling to room temperature, the material is suspended in 20 ml of 1-hexyl-3-methylimidazolium bis(trifluoromethylsulfonyl)imide under protective gas and with stirring. For the end capping, 2.5 ml of dimethyldichlorosilane are added dropwise to the suspension over the course of 10 minutes.

The reaction mixture is subsequently left to react for 5 hours at a bath temperature of 120° C. with stirring and under protective gas.

After the reaction mixture has cooled, the silica gel material is filtered off with suction and rinsed with 3×50 ml of toluene. After the silica gel material has been dried for 4 hours in vacuo, the elemental analysis shows a carbon value of C=19.4%, which means a surface coverage of about 3.45 μmol/m²+0.35 μmol/m², i.e. in total a surface coverage of 3.8 μmol/m².

### Result:

Carbon value C=19.4% (3.80 μmol/m²)

NMR: virtually the same crosslinking as in Experiment 1.2

### 2.3. Procedure at 200° C.

10 g of Purospher® Si 5 μm particles having a specific surface area of 320 m²/g are dried for four hours at 100° C. in vacuo. After cooling to room temperature, the material is suspended in 40 ml of 1-hexyl-3-methylimidazolium bis(trifluoromethylsulfonyl)imide under protective gas and with stirring. For the surface modification, 11.5 g of octadecylmethyldimethoxysilane (10 μmol/m²) are added dropwise to the suspension over the course of 30 minutes. The reaction mixture is subsequently stirred for 5 hours at an internal temperature of 200° C. under protective gas.

After the reaction mixture has cooled, the silica gel material is filtered off with suction and rinsed with 3×100 ml of toluene. After the silica gel material has been dried for 4 hours in vacuo, the elemental analysis shows a carbon value of C=19.6%, which means a surface coverage of about 3.6 μmol/m².

NMR: significantly better crosslinking than in the experiments in toluene.

Chromatographic separation: better (residual silanols less)

2.4 Use of 10 g of Material from Experiment No. 1.3, Further Reaction as Described Under Ex. No. 2.3.

### Result:

Carbon value C=20% about 3.70 μmol/m²

NMR: significantly better crosslinking than in the experiments in toluene.

Chromatographic separation better (residual silanols less)

3. Reactions in Accordance with the Prior Art on Monolithic Materials
3.1. Surface Modification of Monolithic Mouldings in the Batch Process (Comparison with Experiment No. 1.2)

20 pieces of Chromolith® silica mouldings (14 g weight) having a specific surface area of 305 m²/g are dried for four hours at 100° C. in vacuo. After cooling to room temperature, the mouldings are dipped into 250 ml of toluene under protective gas, and complete wetting thereof is awaited. For the surface modification, a mixture of 15.3 g of octadecylmethyldimethoxysilane (10 μmol/m²) in 10 ml of toluene is added dropwise over the course of 30 minutes with gentle stirring.

The reaction mixture is subsequently left to react for 5 hours at a bath temperature of 110° C. under protective gas with gentle stirring. In order to shift the reaction equilibrium, the methanol formed is removed from the reaction mixture with the aid of a distillation bridge.

After the reaction mixture has cooled, the mouldings are left to stand with three times 200 ml of toluene for 1 hour in each case with gentle stirring. After the silica gel material has been dried for 4 hours in vacuo, the elemental analysis shows a carbon value of C=15.7%, which means a surface coverage of about 2.83 μmol/m².

In order to investigate the homogeneity of the modification, an analysis of the edge region and the core of the mouldings is carried out.

Edge: C=19.0% core: C=12.4%, i.e. the carbon distribution inside/outside is very inhomogeneous.

3.2 Procedure with More Silane (Comparison with Experiment No. 1.3)

20 pieces of Chromolith® silica mouldings (14 g weight), having a specific surface area of 305 m²/g, are dried for four hours at 100° C. in vacuo. After cooling to room temperature, the mouldings are dipped into 250 ml of toluene under protective gas, and complete wetting thereof is awaited. For the surface modification, a mixture of 45.9 g of octadecylmethyldimethoxysilane (30 μmol/m²) in 10 ml of toluene is added dropwise over the course of 30 minutes with gentle stirring.

The reaction mixture is subsequently left to react for 5 hours at a bath temperature of 110° C. under protective gas with gentle stirring. In order to shift the reaction equilibrium, the methanol formed is removed from the reaction mixture with the aid of a distillation bridge.

After the reaction mixture has cooled, the mouldings are left to stand with three times 200 ml of toluene for 1 hour in each case with gentle stirring. After the silica gel material has been dried for 4 hours in vacuo, the elemental analysis shows a carbon value of C=17.4%, which means a surface coverage of about 3.23 μmol/m².

In order to investigate the homogeneity of the modification, an analysis of the edge region and the core of the mouldings is carried out.

Edge: C=19.0% core: C=15.8%, i.e. inhomogeneous in the carbon distribution inside/outside.

### 3.3. Surface Modification of Monolithic Mouldings in Through-Flow in Toluene

3 pieces of Chromolith® Performance Si 100×4.6 mm columns (PEEK clad), having a specific surface area of 305 m²/g, are dried for 4 hours at 100° C. in vacuo. After cooling to room temperature, the clad silica gel mouldings are rinsed in with toluene with the aid of an HPLC pump using a flow rate of 1 ml/minute for 5 minutes. For the surface modification, a mixture of 4.8 g of octadecylmethyldimethoxysilane (30 μmol/m²) in 10 ml of toluene is circulated by pumping at a flow rate of 0.5 ml/minute for 5 hours. During the reaction, the mouldings are kept at 100° C. in a fan-assisted drying cabinet.

After cooling, the unreacted silane is washed out of the mouldings using 100 ml of toluene with the aid of a flow rate of 2 ml/minute. After the silica gel material has been dried for 4 hours in vacuo, the elemental analysis shows a carbon value of C=18.0%, i.e. a surface coverage of about 3.38 μmol/m².

In order to investigate the homogeneity of the modification, an analysis of the edge region and the core of the monoliths is carried out.

Edge: C=17.8% core: C=18.2%, i.e. the carbon distribution inside/outside is relatively homogeneous.

An NMR investigation shows poor crosslinking.

4. Surface Modifications on Monolithic Materials Carried Out in Accordance with the Invention
4.1. Surface Modification of Monolithic Mouldings in the Batch Process (Comparison with Ex. No. 3.2)

5 pieces of Chromolith® silica mouldings (3.5 g weight), having a specific surface area of 305 m²/g, are dried for four hours at 100° C. in vacuo. After cooling to room temperature, 20 ml of 1-hexyl-3-methylimidazolium bis(trifluoromethylsulfonyl)imide are added to the mouldings under protective gas, and complete wetting thereof is awaited. For the surface modification, a mixture of 11.3 g of octadecylmethyldimethoxysilane (30 μmol/m²) in 10 ml of 1-hexyl-3-methylimidazolium bis(trifluoromethylsulfonyl)imide is added dropwise over the course of 30 minutes with gentle stirring. The reaction mixture is subsequently left to react for 5 hours at a bath temperature of 110° C. with gentle stirring and under protective gas. In order to shift the reaction equilibrium, the methanol formed is removed from the reaction mixture with the aid of a distillation bridge.

After the reaction mixture has cooled, the mouldings are left to stand with three times 200 ml of toluene for 1 hour in each case with gentle stirring. After the silica gel material has been dried for 4 hours in vacuo, the elemental analysis shows a carbon value of C=18.0%, i.e. a surface coverage of about 3.40 μmol/m².

In order to investigate the homogeneity of the modification, an analysis of the edge region and the core of the mouldings is carried out.

Edge: C=19.0% core: C=17.0%, i.e. inhomogeneous in the carbon distribution inside/outside.

4.2. Surface Modification of Monolithic Mouldings in the Batch Process at Elevated Temperature (Comparison with Ex. No. 2.3)

5 pieces of Chromolith® silica mouldings (3.5 g weight), having a specific surface area of 305 m²/g, are dried for four hours at 100° C. in vacuo. After cooling to room temperature, 20 ml of 1-hexyl-3-methylimidazolium bis(trifluoromethylsulfonyl)imide are added to the mouldings under protective gas, and complete wetting thereof is awaited. For the surface modification, a mixture of 11.3 g of octadecylmethyldimethoxysilane (30 μmol/m²) in 10 ml of 1-hexyl-3-methylimidazolium bis(trifluoromethylsulfonyl)imide is added dropwise over the course of 30 minutes with gentle stirring. The reaction mixture is subsequently left to react for 5 hours at a bath temperature of 200° C. with gentle stirring and under protective gas. In order to shift the reaction equilibrium, the methanol formed is removed from the reaction mixture with the aid of a distillation bridge.

After the reaction mixture has cooled, the mouldings are left to stand with three times 200 ml of toluene for 1 hour in each case with gentle stirring. After the silica gel material has been dried for 4 hours in vacuo, the elemental analysis shows a carbon value of C=19.3%, i.e. a surface coverage of about 3.70 μmol/m².

In order to investigate the homogeneity of the modification, an analysis of the edge region and the core of the mouldings is carried out.

Edge: C=19.5% core: C=19.1%, i.e. homogeneous in the carbon distribution inside/outside.

The chromatographic test is good (shows virtually no residual silanols).

### 4.3. End Capping of No. 4.2 Using Dimethyldimethoxysilane

3 pieces of Chromolith® RP-18 silica mouldings from Experiment 4.2 are dried for four hours at 100° C. in vacuo. After cooling to room temperature, the material is suspended in 20 ml of 1-hexyl-3-methylimidazolium bis(trifluoromethylsulfonyl)imide under protective gas and with stirring. For the end capping, 2.5 ml of dimethyldimethoxysilane are added dropwise to the suspension over the course of 10 minutes.

The reaction mixture is subsequently left to react for 5 hours at a bath temperature of 200° C. with stirring and under protective gas.

After the reaction mixture has cooled, the mouldings are left to stand with three times 100 ml of toluene for 1 hour in each case with gentle stirring. After the silica gel material has been dried for 4 hours in vacuo, the elemental analysis shows a carbon value of C=19.8%, i.e. a surface coverage of about 4.39 μmol/m².

In order to investigate the homogeneity of the modification, an analysis of the edge region and the core of the monoliths is carried out. The results show a homogeneous carbon distribution inside/outside.

The chromatographic test is good (shows virtually no residual silanols).

### 4.4. Surface Modification of Monolithic Mouldings in the Batch Process at Elevated Temperature

5 pieces of Chromolith® silica mouldings (3.5 g weight), having a specific surface area of 305 m²/g, are dried for four hours at 100° C. in vacuo. After cooling to room temperature, 20 ml of 1-hexyl-3-methylimidazolium bis(trifluoromethylsulfonyl)imide are added to the mouldings under protective gas, and complete wetting thereof is awaited. For the surface modification, a mixture of 11.3 g of octadecylmethyldimethoxysilane (30 μmol/m²) in 10 ml of 1-hexyl-3-methylimidazolium bis(trifluoromethylsulfonyl)imide is added dropwise over the course of 30 minutes with gentle stirring. The reaction mixture is subsequently left to react for 5 hours at a bath temperature of 300° C. with gentle stirring and under protective gas. In order to shift the reaction equilibrium, the methanol formed is removed from the reaction mixture with the aid of a distillation bridge.

After the reaction mixture has cooled, the mouldings are left to stand with three times 200 ml of toluene for 1 hour in each case with gentle stirring. After the silica gel material has been dried for 4 hours in vacuo, the elemental analysis shows a carbon value of C=19.4%, i.e. a surface coverage of about 3.73 μmol/m².

In order to investigate the homogeneity of the modification, an analysis of the edge region and the core of the monoliths is carried out.

Edge: C=19.4% core: C=19.4%, i.e. homogeneous in the carbon distribution inside/outside.

The NMR investigation shows good crosslinking.

### 4.5. Surface Modification of Monolithic Mouldings in Through-Flow

3 pieces of Chromolith® Performance Si 100×4.6 mm columns (PEEK clad), having a specific surface area of 305 m²/g, are dried for 4 hours at 100° C. in vacuo. After cooling to room temperature, the clad silica gel mouldings are rinsed in with 1-hexyl-3-methylimidazolium bis(trifluoromethylsulfonyl)imide with the aid of an HPLC pump using a flow rate of 1 ml/minute for 5 minutes. For the surface modification, a mixture of 4.8 g of octadecylmethyldimethoxysilane (30 μmol/m²) in 10 ml of 1-hexyl-3-methylimidazolium bis(trifluoromethylsulfonyl)imide is circulated by pumping at a flow rate of 0.5 ml/minute for 5 hours. During the reaction, the mouldings are kept at 100° C. in a fan-assisted drying cabinet.

After cooling, the unreacted silane is washed out of the mouldings using 100 ml of toluene with the aid of a flow rate of 2 ml/minute. After the silica gel material has been dried for 4 hours in vacuo, the elemental analysis shows a carbon value of C=18.1%, i.e. a surface coverage of about 3.4 μmol/m².

In order to investigate the homogeneity of the modification, an analysis of the edge region and the core of the monoliths is carried out.

Edge: C=18.0% core: C=18.2%, i.e. relatively homogeneous in the carbon distribution.

### 4.6. Surface Modification of Monolithic Mouldings in Through-Flow at 200° C.

3 pieces of Chromolith® Performance Si 100×4.6 mm columns (PEEK clad), having a specific surface area of 305 m²/g, are dried for 4 hours at 100° C. in vacuo. After cooling to room temperature, the clad silica gel mouldings are rinsed in with 1-hexyl-3-methylimidazolium bis(trifluoromethylsulfonyl)imide with the aid of an HPLC pump using a flow rate of 1 ml/minute for 5 minutes. For the surface modification, a mixture of 4.8 g of octadecylmethyldimethoxysilane (30 μmol/m²) in 10 ml of 1-hexyl-3-methylimidazolium bis(trifluoromethylsulfonyl)imide is circulated by pumping at a flow rate of 0.5 ml/minute for 5 hours. During the reaction, the mouldings are kept at 200° C. in a fan-assisted drying cabinet.

After cooling, the unreacted silane is washed out of the mouldings using 100 ml of toluene with the aid of a flow rate of 2 ml/minute. After the silica gel material has been dried for 4 hours in vacuo, the elemental analysis shows a carbon value of C=19.4%, i.e. a surface coverage of about 3.73 μmol/m².

In order to investigate the homogeneity of the modification, an analysis of the edge region and the core of the monoliths is carried out.

Edge: C=19.2% core: C=19.6%, i.e. relatively homogeneous in the carbon distribution inside/outside.

NMR: good crosslinking.

4.7. End Capping of the Material from Experiment No. 4.6 Using Dimethyldimethoxysilane

1 piece of Chromolith® Performance RP-18 100×4.6 mm column (PEEK clad) from Experiment 4.6 is dried for 4 hours at 100° C. in vacuo. After cooling to room temperature, the clad silica gel moulding is rinsed in with 1-hexyl-3-methylimidazolium bis(trifluoromethylsulfonyl)imide with the aid of an HPLC pump using a flow rate of 1 ml/minute for 5 minutes. For the surface modification, a mixture of 1 ml of dimethyldimethoxysilane in 5 ml of 1-hexyl-3-methylimidazolium bis(trifluoromethylsulfonyl)imide is circulated by pumping at a flow rate of 0.3 ml/minute for 5 hours. During the reaction, the moulding is kept at 200° C. in a fan-assisted drying cabinet.

After cooling, the unreacted silane is washed out of the moulding using 50 ml of toluene with the aid of a flow rate of 1 ml/minute. After the silica gel material has been dried for 4 hours in vacuo, the elemental analysis shows a carbon value C=19.8%, i.e. a surface coverage of about 4.28 μmol/m².

In order to investigate the homogeneity of the modification, an analysis of the edge region and the core of the monoliths is carried out.

Edge: C=19.7% core: C=19.9%.

NMR: good crosslinking.

### 4.8. Surface Modification of Monolithic Mouldings at 200° C. in a Pressure Autoclave

3 pieces of Chromolith® Performance Si 100×4.6 mm columns (PEEK clad), having a specific surface area of 305 m²/g, are dried for 4 hours at 100° C. in vacuo. For the surface modification, the mouldings are filled with a mixture of 1.6 g of octadecylmethyldimethoxysilane (10 μmol/m²) in 5 ml of 1-hexyl-3-methylimidazolium bis(trifluoromethylsulfonyl)imide. For the reaction, the mouldings are secured against running out at the lower end using blank caps and left to react in a sealed pressure autoclave for five hours at 200° C. under protective gas.

After cooling, the unreacted silane is washed out of the mouldings using 100 ml of toluene with the aid of a flow rate of 2 ml/minute. After the silica gel material has been dried for 4 hours in vacuo, the elemental analysis shows a carbon value of C=19.6%, i.e. a surface coverage of about 3.78 μmol/m².

In order to investigate the homogeneity of the modification, an analysis of the edge region and the core of the monoliths is carried out.

Edge: C=19.7% core: C=19.5%.

NMR: good crosslinking and homogeneous in the carbon distribution inside/outside

4.9. Monolith Batch with More Silane in Ionic Liquid 200° C.

5 pieces of Chromolith® silica mouldings (3.5 g weight), having a specific surface area of 305 m²/g, are dried for four hours at 100° C. in vacuo. After cooling to room temperature, 20 ml of 1-hexyl-3-methylimidazolium bis(trifluoromethylsulfonyl)imide are added to the mouldings under protective gas, and complete wetting thereof is awaited. For the surface modification, a mixture of 11.8 g of octadecyltrimethoxysilane (30 μmol/m²) in 10 ml of 1-hexyl-3-methylimidazolium bis(trifluoromethylsulfonyl)imide is added dropwise over the course of 30 minutes with gentle stirring. The reaction mixture is subsequently left to react for 5 hours at a bath temperature of 200° C. with gentle stirring and under protective gas. In order to shift the reaction equilibrium, the methanol formed is removed from the reaction mixture with the aid of a distillation bridge.

After the reaction mixture has cooled, the mouldings are left to stand with three times 200 ml of toluene for 1 hour in each case with gentle stirring. After the silica gel material has been dried for 4 hours in vacuo, the elemental analysis shows a carbon value of C=19.3%, i.e. a surface coverage of about 3.91 μmol/m².

In order to investigate the homogeneity of the modification, an analysis of the edge region and the core of the monoliths is carried out.

Edge: C=19.3% core: C=19.3%.

NMR: good crosslinking and homogeneous in the carbon distribution inside/outside.

4.10. End Capping of the Material from Experiment No. 4.9 Using Dimethyldimethoxysilane at 200° C.

3 pieces of Chromolith® RP-18 silica mouldings from Experiment 4.9 are dried for four hours at 100° C. in vacuo. After cooling to room temperature, the material is suspended in 20 ml of 1-hexyl-3-methylimidazolium bis(trifluoromethylsulfonyl)imide under protective gas and with stirring. For the end capping, 2.5 ml of dimethyldimethoxysilane are added dropwise to the suspension over the course of 10 minutes.

The reaction mixture is subsequently left to react for 5 hours at a bath temperature of 200° C. with stirring and under protective gas.

After the reaction mixture has cooled, the mouldings are left to stand with three times 100 ml of toluene for 1 hour in each case with gentle stirring. After the silica gel material has been dried for 4 hours in vacuo, the elemental analysis shows a carbon value of C=19.8%, i.e. a surface coverage of about 4.60 μmol/m².

NMR: good crosslinking and homogeneous in the carbon distribution inside/outside

### 5. Additional Formation of a Polymer Layer

5.1. Reaction of a Monolithic Moulding with Vinylsilane and Subsequent Polymerisation with Styrene/Divinylbenzene

5 pieces of Chromolith® silica mouldings (3.5 g weight), having a specific surface area of 305 m²/g, are dried for four hours at 100° C. in vacuo. After cooling to room temperature, 20 ml of 1-hexyl-3-methylimidazolium bis(trifluoromethylsulfonyl)imide are added to the mouldings under protective gas, and it complete wetting thereof is awaited. For the surface modification, a mixture of 4.7 g of vinyltrimethoxysilane (30 μmol/m²) in 10 ml of 1-hexyl-3-methylimidazolium bis(trifluoromethylsulfonyl)imide is added dropwise over the course of 30 minutes with gentle stirring. The reaction mixture is subsequently left to react for 5 hours at a bath temperature of 200° C. with gentle stirring and under protective gas. In order to shift the reaction equilibrium, the methanol formed is removed from the reaction mixture with the aid of a distillation bridge.

After the reaction mixture has cooled, the mouldings are left to stand with three times 200 ml of toluene for 1 hour in each case with gentle stirring. After the silica gel material has been dried for 4 hours in vacuo, the elemental analysis shows a carbon value of C=15.8%, i.e. a surface coverage of about 3.69 μmol/m².

For the surface polymerisation, 10 ml of 1-hexyl-3-methylimidazolium bis(trifluoromethylsulfonyl)imide are added under protective gas to three Chromolith® vinyl silica mouldings (about 2.25 g weight), and complete wetting thereof is awaited.

For the surface polymerisation, a mixture of 2.14 g of styrene (30 μmol/m² without stabiliser) and 2.67 g of 1,4-divinylbenzene (30 μmol/m² without stabiliser) and 0.2 g of AIBN (2,2′-azobis(2-methylpropionitrile) in 10 ml of 1-hexyl-3-methylimidazolium bis(trifluoromethylsulfonyl)imide is added dropwise over the course of 5 minutes with gentle stirring. The reaction mixture is subsequently left to react for 5 hours at a bath temperature of 200° C. with gentle stirring and under protective gas.

After the reaction mixture has cooled, the mouldings are left to stand with three times 200 ml of toluene for 1 hour in each case with gentle stirring. After the silica gel material has been dried for 4 hours in vacuo, the elemental analysis shows a carbon value of C=24.9%, i.e. a surface coverage of about 7.89 μmol/m², which means substantially complete surface screening.

1. Process for the surface modification of solid support materials, characterised by the following reaction steps
a) provision of a solid support material
b) reaction of the solid support material with silanes in the presence of ionic liquid as solvent
c) separation of the support material
d) optionally washing and drying of the support material.

2. Process according to claim 1, characterised in that the solid support material provided in step a) is a silica gel material.

3. Process according to claim 1, characterised in that the support material provided in step a) is a monolithic silica gel material.

4. Process according to claim 1, characterised in that the reaction in step b) is carried out in the presence of pure ionic liquid without addition of organic solvents.

5. Process according to claim 1, characterised in that the reaction in step b) is carried out at a temperature between 200 and 400° C.

6. Process according to claim 1, characterised in that the reaction in step b) is carried out in the presence of a hydrophobic ionic liquid.

7. Process according to claim 1, characterised in that the silanes employed in step b) are bifunctional silanes.

8. Process according to claim 1, characterised in that a support material which already carries separation effectors is employed in step a).

9. Process according to claim 1, characterised in that a polymer layer is applied in a subsequent step f).
